(19) United States
(12) Patent Application Publication
(10) Pub. No.: US 2017/0242378 A1
(43) Pub. Date: Aug. 24, 2017

(54) IMAGE FORMING APPARATUS

(71) Applicant: FUJI XEROX CO., LTD., Tokyo (JP)

(72) Inventors: Yuichiro SAITO, Kanagawa (JP); Koichi IMAZU, Kanagawa (JP)

(73) Assignee: FUJI XEROX CO., LTD., Tokyo (JP)

(21) Appl. No.: 15/226,144

(22) Filed: Aug. 2, 2016

(30) Foreign Application Priority Data
Feb. 23, 2016 (JP) 2016-031797

(51) Int. Cl. G03G 15/20

(52) U.S. Cl. CPC G03G 15/2071; G03G 15/1605; G03G 15/2085; G03G 15/2089

(57) ABSTRACT

An image forming apparatus includes an apparatus body having an image forming unit that is configured to an image on a recording material, and a fixing unit removably attached to the apparatus body to fix the image on the recording material. The fixing unit includes a roll member having a roll body and a bearing provided at each end of the roll body to support the roll body rotatably, a pressurizing member provided in contact with the roll member to form a fixing pressurizing portion through which the recording material passes, and a storage member that stores the roll member and the pressurizing member in a state in which the roll member and the pressurizing member are pressed with a predetermined pressure. The apparatus body includes a positioning member that is in contact with the bearing to position the roll member in a transport direction of the recording material.

### CROSS-REFERENCE TO RELATED APPLICATIONS

This application is based on and claims priority under 35 USC 119 from Japanese Patent Application No. 2016-031797 filed Feb. 23, 2016.

### BACKGROUND

### (i) Technical Field

The present invention relates to an image forming apparatus.

### (ii) Related Art

In an image forming apparatus, a unit, such as a fixing unit for fixing an image on a recording material, is sometimes removably attached to an apparatus body of the image forming apparatus.

In an image forming apparatus in which a unit including a roll member stored in a storage member is removably attached to an apparatus body, for example, the roll member is sometimes positioned via the storage member. When such a structure is adopted, it is sometimes difficult to place the roll member at a predetermined position and in a predetermined orientation in the image forming apparatus, for example, owing to dimensional error of the storage member and deformation of the storage member.

### SUMMARY

According to an aspect of the invention, there is provided an image forming apparatus including an apparatus body including an image forming unit that is configured to form an image on a recording material, and a fixing unit that is removably attached to the apparatus body and is configured to fix the image on the recording material on which the image is formed by the image forming unit, wherein the fixing unit includes a roll member having a cylindrical roll body and a bearing provided at each end of the roll body to support the roll body rotatably, a pressurizing member provided in contact with the roll member to form, between the pressurizing member and the roll member, a fixing pressurizing portion through which the recording material passes, and a storage member that is configured to store the roll member and the pressurizing member in a state in which the roll member and the pressurizing member are pressed with a predetermined pressure, and wherein the apparatus body includes a positioning member that is in contact with the bearing of the roll member stored in the storage member to position the roll member in a transport direction of the recording material

### BRIEF DESCRIPTION OF THE DRAWINGS

Exemplary embodiments of the present invention will be described in detail based on the following figures, wherein:

FIG. 1 illustrates a structural example of an image forming apparatus to which a first exemplary embodiment is applied;

FIG. 2 is a cross-sectional view of a fixing unit of the first exemplary embodiment, taken along a plane perpendicular to an axial direction of the fixing unit;

FIG. 3 illustrates a heating roller and a first frame in the fixing unit, when viewed in the axial direction from an axial end side;

FIG. 4 is a cross-sectional view schematically illustrating an attachment state of the heating roller to the first frame when the heating roller supported by the first frame is cut in a plane along the axial direction and a pressurizing direction;

FIG. 5 illustrates a state in which the fixing unit is attached to the image forming apparatus when the fixing unit attached to the image forming apparatus is viewed in the axial direction;

FIG. 6 illustrates the relationship between the heating roller and an attachment member in the state in which the fixing unit is attached to the image forming apparatus when the heating roller and the attachment member are viewed in the pressurizing direction;

FIG. 7 illustrates the shape of a bearing positioning portion according to a second exemplary embodiment and a state in which a bearing is positioned by the bearing positioning portion; and

FIGS. 8A and 8B explain problems caused when the heating roller is positioned via a unit frame.

### DETAILED DESCRIPTION

Exemplary embodiments of the present invention will be described below with reference to the attached drawings.

### First Exemplary Embodiment

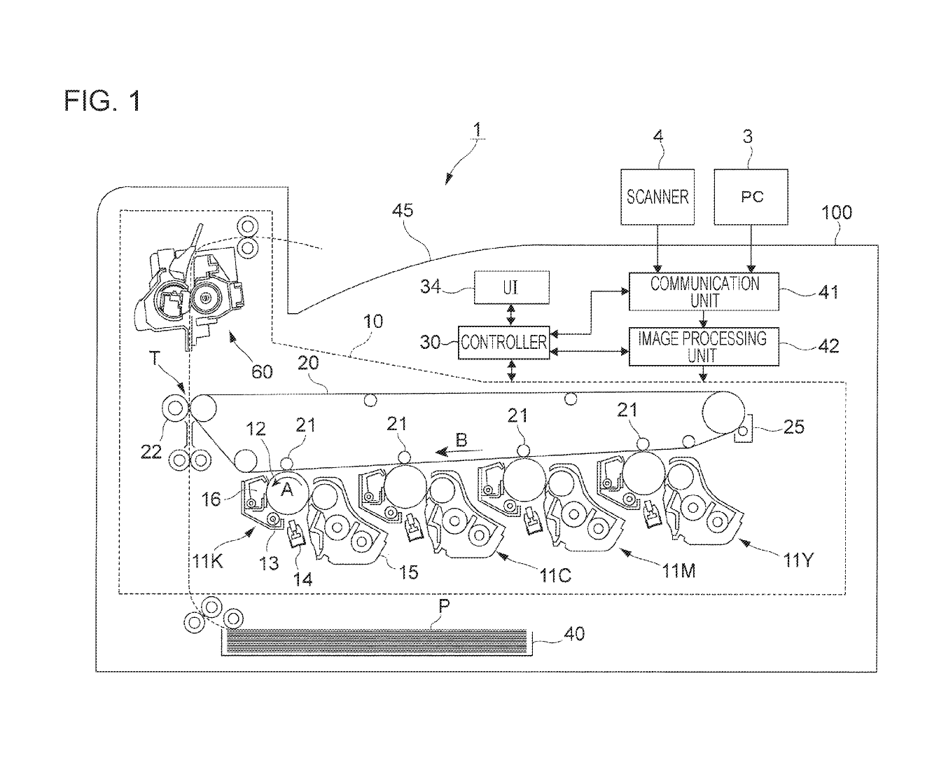

FIG. 1 illustrates a structural example of an image forming apparatus 1 to which a first exemplary embodiment is applied. The image forming apparatus 1 illustrated in FIG. 1 is a so-called tandem color printer, and includes an image forming section 10, a controller 30, a paper holding unit 40, and a paper stack unit 45. The image forming section 10 performs image formation on the basis of image data. The controller 30 serves as an example of a control unit that controls the entire operation of the image forming apparatus 1. The paper holding unit 40 holds paper P to be supplied to the image forming apparatus 1. Paper P on which an image is formed is put into the paper stack unit 45. The image forming apparatus 1 further includes a communication unit 41 and an image processing unit 42. The communication unit 41 communicates with, for example, a personal computer (PC) 3 and an image reading device (scanner) 4 and receives image data. The image processing unit 42 subjects the image data received by the communication unit 41 to a predetermined image processing operation. The image forming apparatus 1 further includes a user interface (UI) 34 serving as an example of a display that is formed by a display panel or the like, receives information from the user, and displays information to the user.

As illustrated in FIG. 1, the components of the image forming apparatus 1 of the first exemplary embodiment are stored inside a housing 100.

The image forming section 10 includes four image forming units 11Y, 11M, 11C, and 11K (also generically referred to as “image forming units 11”) arranged in parallel at a fixed interval to serve as an example of an image forming unit. Each of the image forming units 11 includes a photoconductor drum 12 on which an electrostatic latent image is formed and a toner image is born, a charging unit 13 that charges a surface of the photoconductor drum 12 with a predetermined potential, a light emitting diode (LED) print head 14 that exposes the photoconductor drum 12 charged by the charging unit 13 on the basis of color image data, a developing unit 15 that develops the electrostatic latent image formed on the photoconductor drum 12, and a drum cleaner 16 that cleans the surface of the photoconductor drum 12 after transfer.

The image forming units 11 are similar in structure except for toner to be stored in the developing unit 15, and form yellow (Y), magenta (M), cyan (C), and black (K) toner images.

The image forming section 10 further includes an intermediate transfer belt 20 on which color toner images formed by photoconductor drums 12 in the image forming units 11 are to be multiply transferred, and first transfer rollers 21 that sequentially transfer (first-transfer) the color toner images formed by the image forming units 11 onto the intermediate transfer belt 20. The image forming section 10 further includes a second transfer roller 22 that collectively transfers (second-transfers) the color toner images superimposed and transferred on the intermediate transfer belt 20 onto paper P serving as a recording material (recording paper), a belt cleaner 25 that cleans a surface of the intermediate transfer belt 20 after second transfer, and a fixing unit 60 serving as an example of a unit part removably attached to an apparatus body (housing 100) of the image forming apparatus 1 to fix the second-transferred color toner images on the paper P.

In the image forming apparatus 1 of the first exemplary embodiment, an image forming operation is performed through the following processes under operation control of the controller 30. That is, image data from the PC 3 and the scanner 4 is received by the communication unit 41, is subjected to predetermined image processing by the image processing unit 42, and is transmitted as color image data to the image forming units 11. For example, in the image forming unit 11K that forms a black (K) toner image, the photoconductor drum 12 is charged with a predetermined potential by the charging unit 13 while rotating in a direction of arrow A, and is scanned and exposed by the LED print head 14 according to black (K) color image data transmitted from the image processing unit 42. Thus, an electrostatic latent image relating to a black color image is formed on the photoconductor drum 12. The black (K) color electrostatic latent image formed on the photoconductor drum 12 is developed by the developing unit 15 to form a black (K) color toner image on the photoconductor drum 12. Similarly, yellow (Y), magenta (M), and cyan (C) color toner images are formed in the image forming units 11Y, 11M, and 11C, respectively.

The color toner images formed on the photoconductor drums 12 in the image forming units 11 are electrostatically transferred (first-transferred) in order onto the intermediate transfer belt 20 moving in a direction of arrow B by the first transfer rollers 21, and are superimposed to form a superimposed toner image. The superimposed toner image on the intermediate transfer belt 20 is transported to an area (second transfer portion T), where the second transfer roller 22 is disposed, along with movement of the intermediate transfer belt 20. When the superimposed toner image is transported to the second transfer portion T, paper P is supplied from the paper holding unit 40 to the second transfer portion T in timing thereto. Then, the superimposed toner image is collectively and electrostatically transferred (second-transferred) onto the transported paper P by a transfer electric field generated by the second transfer roller 22 at the second transfer portion T.

After that, the paper P on which the superimposed toner image is electrostatically transferred is transported to the fixing unit 60. The toner image on the paper P transported to the fixing unit 60 is heated and pressurized by the fixing unit 60 and is fixed on the paper P. After the fixed image is formed, the paper P is transported to the paper stack unit 45 provided in an output section of the image forming apparatus 1.

On the other hand, toner adhering to the photoconductor drum 12 after first transfer (first-transfer residual toner) and toner adhering to the intermediate transfer belt 20 after second transfer (second-transfer residual toner) are removed by the drum cleaner 16 and the belt cleaner 25, respectively.

In this way, the image forming operation is repeated in cycles corresponding to the number of prints in the image forming apparatus 1.

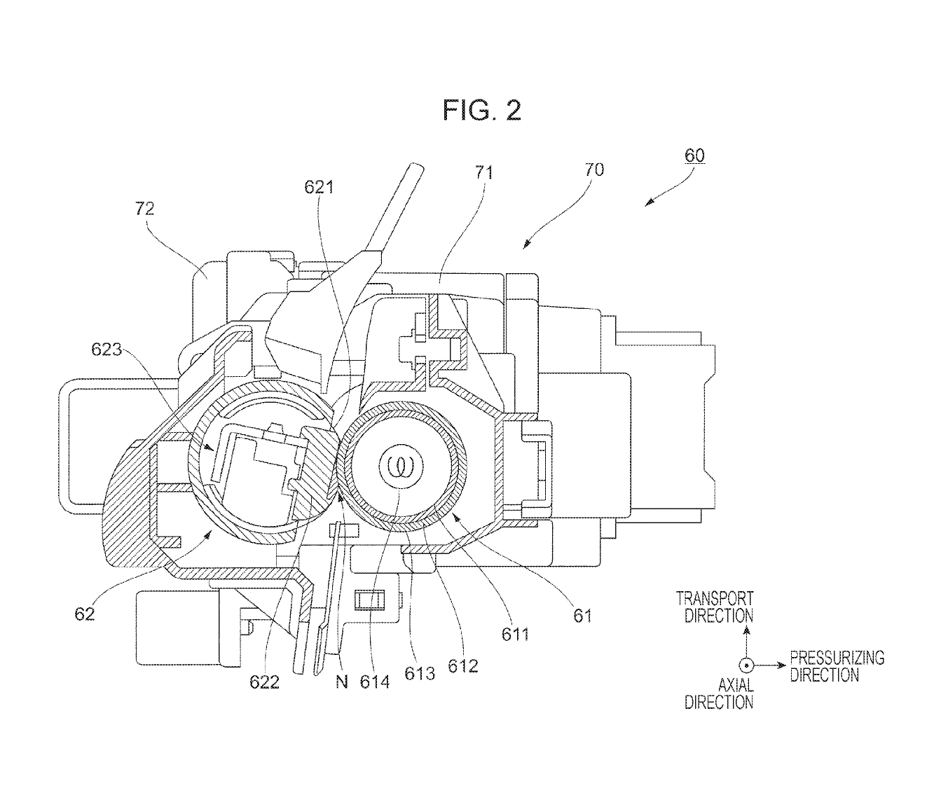

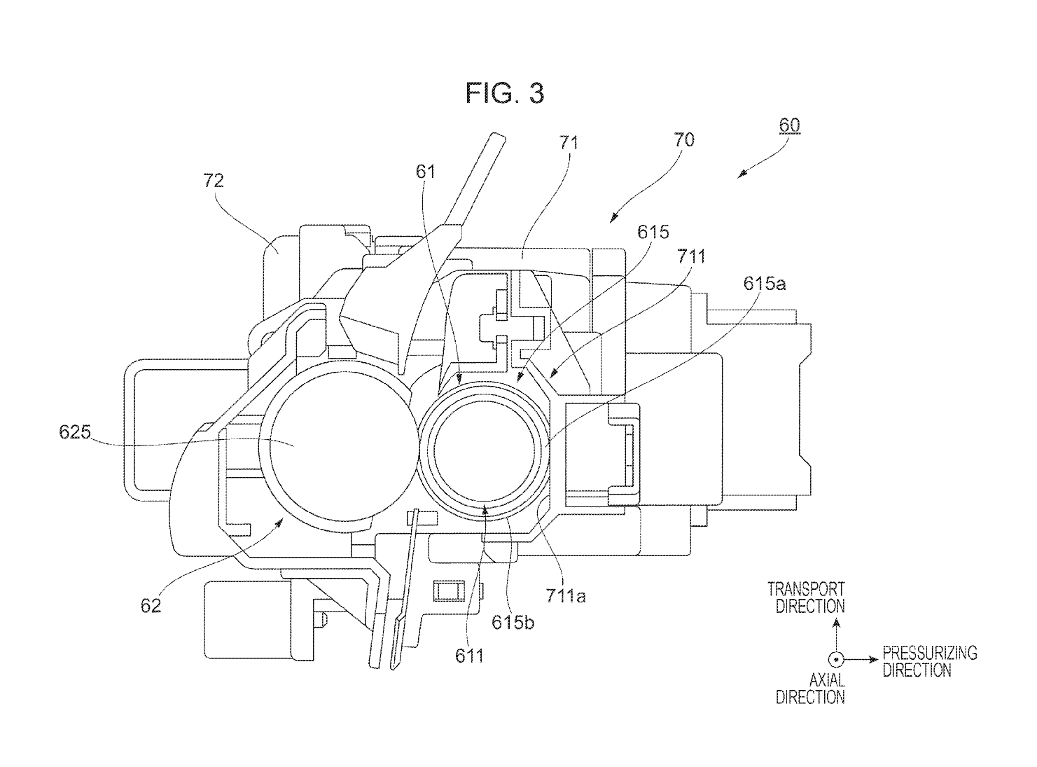

Next, the structure of the fixing unit 60 of the first exemplary embodiment will be described. FIG. 2 is a cross-sectional view of the fixing unit 60 according to the first exemplary embodiment, taken along a plane perpendicular to an axial direction to be described later. FIG. 3 illustrates a heating roller 61 and a first frame 71 in the fixing unit 60 to be described later, when viewed in the axial direction from an axial end side.

As described above, the fixing unit 60 of the first exemplary embodiment is removably attached to the apparatus body of the image forming apparatus 1 (see FIG. 1).

As illustrated in FIG. 2, the fixing unit 60 of the first exemplary embodiment includes a heating roller 61 serving as an example of a roll member that heats a recording material transported to the fixing unit 60, and a pressurizing module 62 serving as an example of a pressurizing member that pressurizes the heating roller 61 to form a nip (fixing pressurizing portion) N therebetween. The fixing unit 60 of the first exemplary embodiment further includes a unit frame 70 serving as an example of a storage member that stores and supports the heating roller 61 and the pressurizing module 62.

As illustrated in FIG. 2, the unit frame 70 is composed of a first frame 71 that supports the heating roller 61 rotatably and a second frame 72 that supports the pressurizing module 62 rotatably. In the fixing unit 60 of the first exemplary embodiment, the first frame 71 and the second frame 72 are connected to each other. Thus, in the fixing unit 60, the heating roller 61 is pressed (pressurized) by the pressurizing module 62, and the nip N is formed between the heating roller 61 and the pressurizing module 62.

In the fixing unit 60 of the first exemplary embodiment, when a fixing operation is performed, the heating roller 61 is rotated in the clockwise direction in FIG. 2 and the pressurizing module 62 (a pressurizing belt 621 to be described later) is rotated in the counterclockwise direction in FIG. 2 by an unillustrated driving unit. Thus, at the nip N, a recording material is transported from a lower side toward an upper side of FIG. 2 and an image is fixed on the recording material.

In the following description, a direction along the rotation axis of the heating roller 61 (a direction perpendicular to the plane of FIG. 2) is sometimes simply referred to as an “axial direction”, a transport direction of the recording material at the nip N (a direction from the lower side toward the upper side of FIG. 2) is sometimes simply referred to as a “transport direction”, and a pressurizing direction of the pressurizing module 62 (a direction from the left side toward the right side of FIG. 2) is sometimes simply referred to as a “pressurizing direction.”

The heating roller 61 includes a cylindrical base 611, a heat-resistant elastic layer 612 provided on an outer periphery of the base 611, and a release layer 613 provided on a surface of the heat-resistant elastic layer 612. The heating roller 61 further includes a halogen heater 614 disposed inside the base 611 to function as a heat generation source. The heating roller 61 further includes bearings 615 each of which is formed by, for example, a ball bearing and is attached to a corresponding axial end of the heating roller 61 to support the base 611 rotatably. In the first exemplary embodiment, the base 611, the heat-resistant elastic layer 612, and the release layer 613 constitute a roller body of the heating roller 61.

The base 611 is formed of a metal having high thermal conductivity, for example, iron, aluminum, or SUS.

The heat-resistant elastic layer 612 is formed of an elastic material having high heat resistance. While the material of the heat-resistant elastic layer 612 is not particularly limited, for example, silicone rubber or fluororubber is used.

The release layer 613 is formed of heat-resistant resin. While the material of the release layer 613 is not particularly limited, examples of the material include PFA resin, PTFE resin, fluororesin, silicone resin, fluorosilicone rubber, and silicone rubber. Among of these materials, fluororesin is suitably used from the viewpoint of releasability for toner and wear resistance.

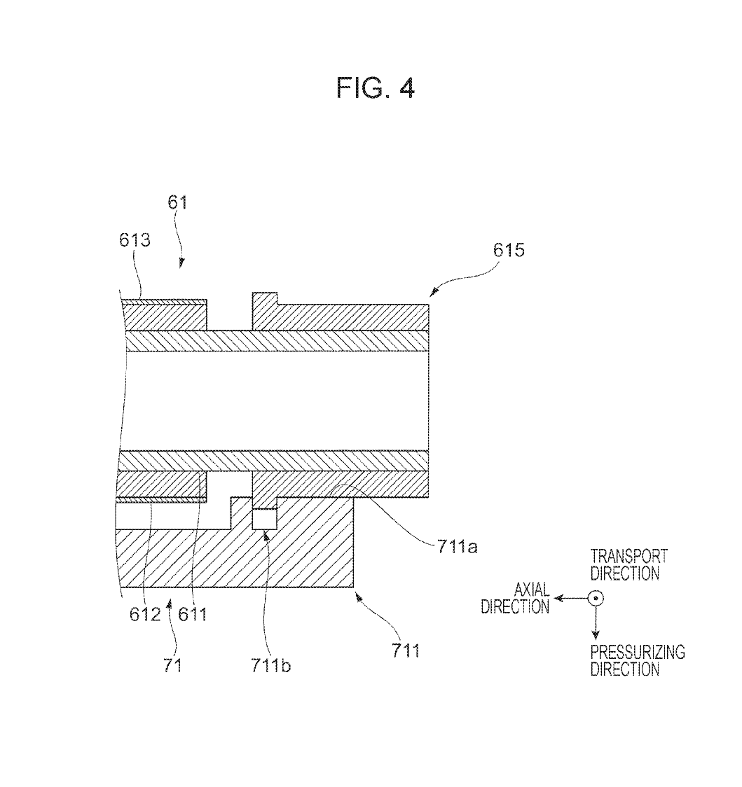

Each bearing 615 is shaped like a cylinder, and has an insertion portion 615a with a columnar opening in which the base 611 of the heating roller 61 is inserted. Each bearing 615 also has a flange portion 615b projecting from an outer peripheral surface of the insertion portion 615a (also see FIG. 4 to be described later).

The pressurizing module 62 includes a pressurizing belt 621 disposed in contact with an outer peripheral surface of the heating roller 61 to form the nip N therebetween, a pressure pad 622 provided on an inner side of the pressurizing belt 621 to press the heating roller 61 with the pressurizing belt 621 being disposed therebetween, and a support member 623 that supports the pressure pad 622. The pressurizing module 62 further includes end cap members 625 that hold the pressurizing belt 621 while keeping a circular cross section at both end portions of the pressurizing belt 621.

The pressurizing belt 621 is formed by an endless belt member originally having, for example, a cylindrical shape. In the pressurizing belt 621, a base layer formed by a sheet member having high heat resistance, an elastic layer disposed on the base layer, and a surface release layer disposed on the elastic layer and exposed on the outer peripheral surface of the pressurizing belt 621 are stacked in order from an inner peripheral surface side.

As the base layer, a flexible material having high mechanical strength and high heat resistance is used. Examples of the material of the base layer include fluororesin, polyimide resin, polyamide resin, polyamide-imide resin, polyetheretherketone (PEEK) resin, polyethersulfone (PES) resin, polyphenylene sulfide (PPS) resin, PFA resin, polytetrafluoroethylene (PTFE) resin, and fluorinated ethylene-propylene copolymer (FEP) resin.

As the elastic layer, for example, silicone rubber, fluororubber, and fluorosilicone rubber that are excellent in heat resistance and thermal conductivity are used.

As the surface release layer, for example, PFA resin, PTFE resin, fluororesin, silicone resin, fluorosilicone rubber, and silicone rubber are used.

The pressure pad 622 and the support member 623 are provided along the width direction of the pressurizing belt 621 on an inner periphery of the pressurizing belt 621. The pressure pad 622 supported by the support member 623 presses the heating roller 61 with the pressurizing belt 621 being disposed therebetween to form the nip N therebetween.

The pressure pad 622 is formed of, for example, an elastic material such as silicone rubber or fluororubber or a heat-resistant resin such as a liquid crystal polymer (LCP) or PPS.

The unit frame 70 (first frame 71 and second frame 72) of the first exemplary embodiment is formed of, for example, resin having high mechanical strength and high heat resistance such as a so-called engineering plastic material. Specific examples of such a resin include phenol resin, polyimide resin, polyamide resin, polyamide-imide resin, PEEK resin, PES resin, PPS resin, and LCP resin. By forming the unit frame 70 of resin, the weight of the unit frame 70 may be made less than when the unit frame 70 is formed of, for example, a metal material such as SUS.

The first frame 71 is provided along the axial direction of the heating roller 61. Opposite axial end portions of the first frame 71 have their respective bearing attachment portions 711 to which the corresponding bearings 615 at the opposite ends of the heating roller 61 are attached.

The second frame 72 is provided along the axial direction of the pressurizing module 62. Opposite axial end portions of the second frame 72 have their respective cap attachment portions (not illustrated) to which the corresponding end cap members 625 at the opposite ends of the pressurizing module 62 are attached.

In the fixing unit 60 of the first exemplary embodiment, the heating roller 61 and the pressurizing module 62 are pressed with a predetermined pressing force in the unit frame 70 by connecting the first frame 71 to which the heating roller 61 is attached and the second frame 72 to which the pressurizing module 62 is attached. Thus, the nip N is formed between the heating roller 61 and the pressurizing module 62.

FIG. 4 schematically illustrates an attachment state of the heating roller 61 to the first frame 71, and is a cross-sectional view of the heating roller 61 supported by the first frame 71, taken in a plane along the axial direction and the pressurizing direction. In FIG. 4, for example, an internal structure of the heating roller 61 is not illustrated.

As illustrated in FIG. 4 and FIG. 3 described above, each bearing attachment portion 711 has a pressed surface 711a serving as an example of a pressed portion which is provided along a plane intersecting the pressurizing direction and against which the corresponding bearing 615 of the heating roller 61 is pressed in the pressurizing direction. Further, as illustrated in FIG. 4, each bearing attachment portion 711 has an insertion portion 711b shaped like a groove recessed in the pressurizing direction so that the flange portion 615b of the bearing 615 is inserted.

In the fixing unit 60 of the first exemplary embodiment, the heating roller 61 is positioned relative to the first frame 71 by attaching the bearings 615 of the heating roller 61 to the corresponding bearing attachment portions 711 of the first frame 71.

Specifically, the flange portions 615b of the bearings 615 provided at the opposite ends of the heating roller 61 are inserted in the insertion portions 711b of the first frame 71. Thus, the heating roller 61 is positioned in the axial direction relative to the first frame 71 via the bearings 615.

Further, when the first frame 71 and the second frame 72 are connected and the heating roller 61 and the pressurizing module 62 are pressed, as described above, the heating roller 61 is pressed in the pressurizing direction by the pressurizing module 62 and is pressed against the first frame 71. Thus, as illustrated in FIG. 4, the insertion portions 615a of the bearings 615 provided at the opposite ends of the heating roller 61 are pressed against the pressed surfaces 711a of the bearing attachment portions 711 in the first frame 71. As a result, the bearings 615 of the heating roller 61 are positioned in the pressurizing direction relative to the first frame 71 of the unit frame 70.

In this way, in the fixing unit 60 of the first exemplary embodiment, the heating roller 61 is positioned in the axial direction and the pressurizing direction relative to the unit frame 70 by connecting the first frame 71 and the second frame 72. Further, in the fixing unit 60 of the first exemplary embodiment, the pressurizing module 62 is positioned in the pressurizing direction relative to the heating roller 61 by being pressed against the heating roller 61.

As illustrated in FIGS. 3 and 4, in the state in which the heating roller 61 is attached to the first frame 71 in the fixing unit 60 of the first exemplary embodiment, end portions of the bearings 615 protrude from the bearing attachment portions 711 toward axial ends (outward).

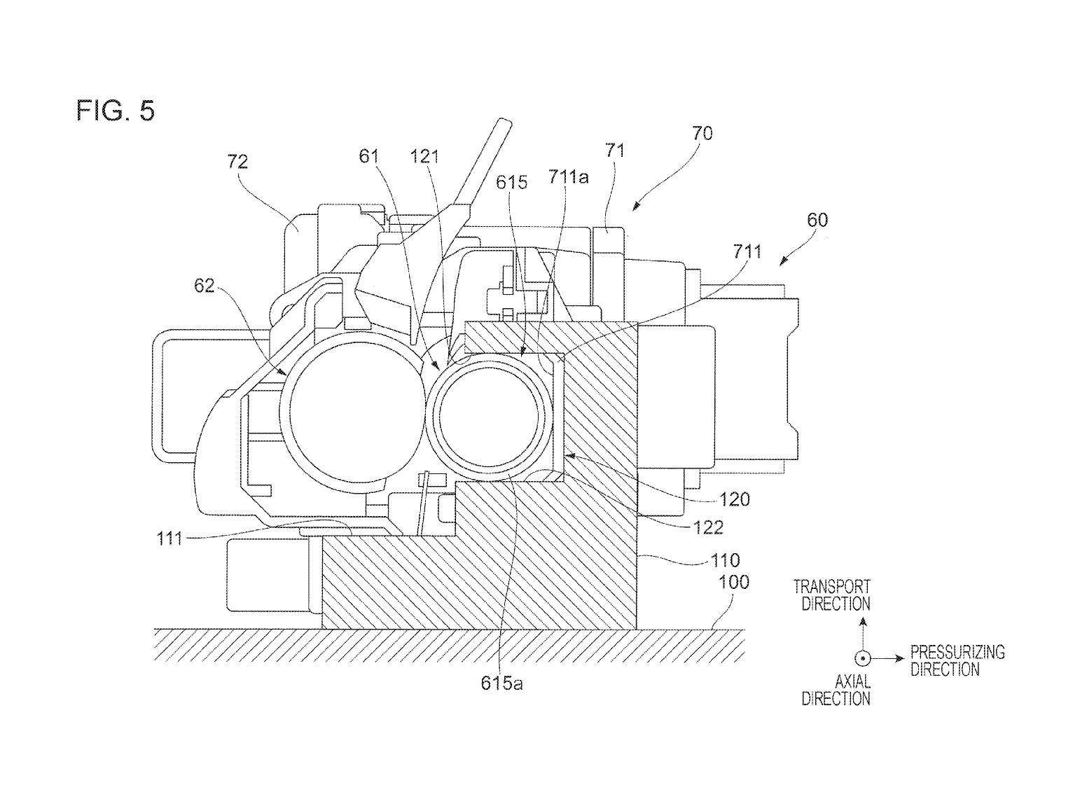

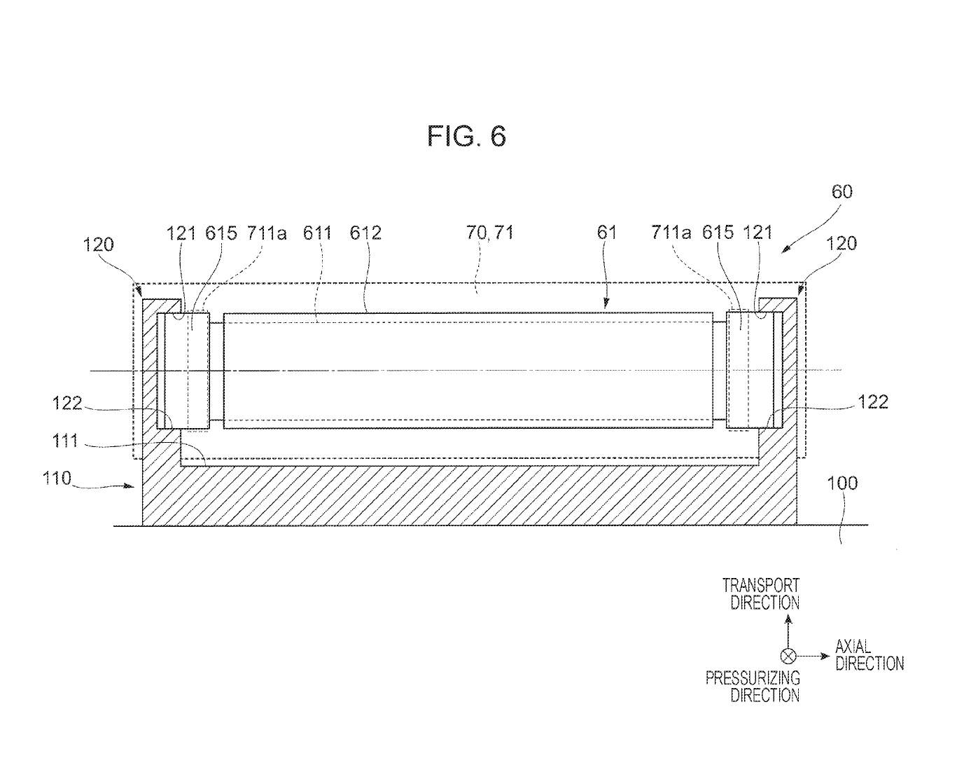

Next, attachment of the fixing unit 60 to the image forming apparatus 1 will be described. FIG. 5 illustrates a state in which the fixing unit 60 is attached to the image forming apparatus 1 when the fixing unit 60 attached to the image forming apparatus 1 is viewed in the axial direction. FIG. 6 illustrates the relationship between the heating roller 61 and an attachment member 110 to be described later in the state in which the fixing unit 60 is attached to the image forming apparatus 1 when the heating roller 61 and the attachment member 110 are viewed in the pressurizing direction.

The image forming apparatus 1 of the first exemplary embodiment includes an attachment member 110 provided inside the housing 100 so that the fixing unit 60 is attached thereto. The attachment member 110 of the first exemplary embodiment is fixed to the housing 100 of the image forming apparatus 1.

As illustrated in FIGS. 5 and 6, the attachment member 110 of the first exemplary embodiment includes bearing positioning portions 120 serving as an example of a positioning member in which the bearings 615 of the heating roller 61 in the fixing unit 60 are inserted to position the bearings 615 (heating roller 61) relative to the apparatus body of the image forming apparatus 1. The attachment member 110 further includes a guide portion 111 that is in contact with the unit frame 70 to guide insertion of the fixing unit 60.

In the image forming apparatus 1 of the first exemplary embodiment, the fixing unit 60 is entirely positioned relative to the image forming apparatus 1 by inserting the bearings 615 of the heating roller 61 in the bearing positioning portions 120 of the attachment member 110. The structure of the attachment member 110 and positioning of the fixing unit 60 relative to the image forming apparatus 1 will be described in detail later.

Conventionally, when the fixing unit 60 is attached to the apparatus body of the image forming apparatus 1, the heating roller 61 and the pressurizing module 62 pressed against the heating roller 61 are sometimes positioned via the unit frame 70. In other words, the fixing unit 60 is sometimes positioned relative to the image forming apparatus 1 by bringing the unit frame 70 of the fixing unit 60 into contact with, for example, a seating surface fixed to the housing 100 of the image forming apparatus 1.

In this case, as will be described later, the positioning accuracy of the heating roller 61 and the pressurizing module 62 in the image forming apparatus 1 sometimes deteriorates owing to, for example, an error of the outer shape of the unit frame 70 and an error of the attachment position of the heating roller 61 in the unit frame 70.

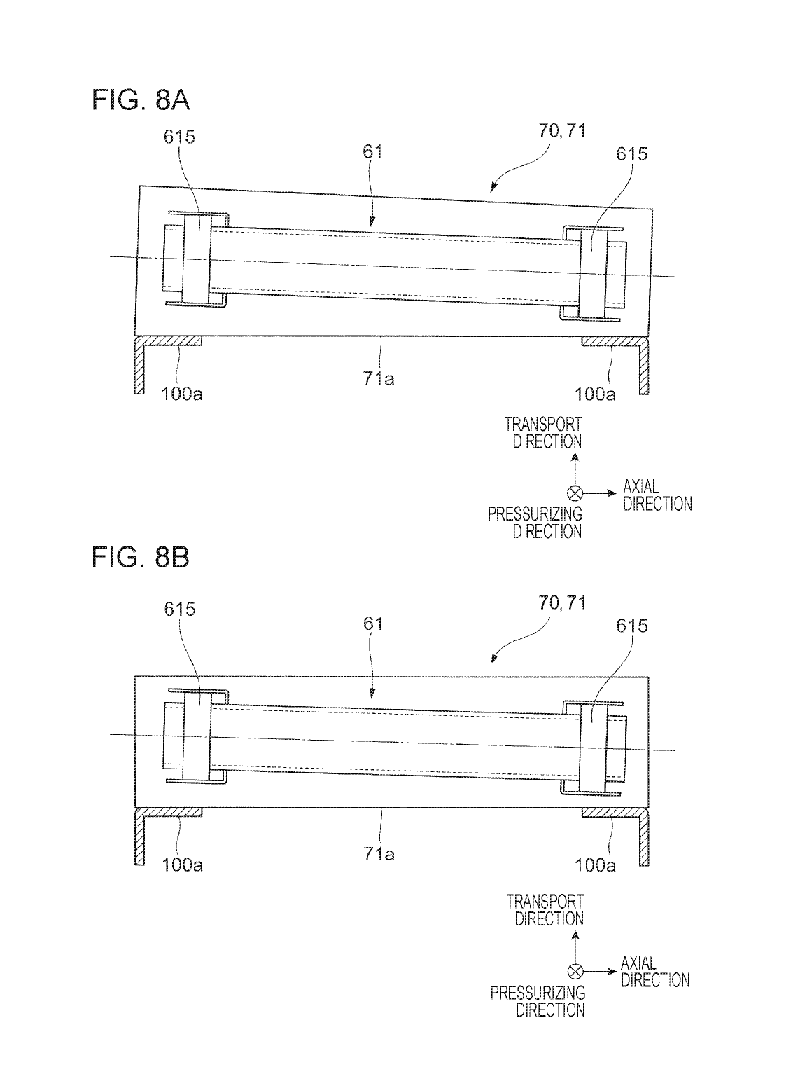

FIGS. 8A and 8B illustrate problems caused when the heating roller 61 is positioned via the unit frame 70. FIG. 8A illustrates an example in which there is an error of the outer shape of the unit frame 70, and FIG. 8B illustrates an example in which there is an error of arrangement of the heating roller 61 in the unit frame 70. FIGS. 8A and 8B correspond to a view of the first frame 71 and the heating roller 61 attached to the image forming apparatus 1 from the pressurizing direction. Further, in the examples of FIGS. 8A and 8B, the fixing unit 60 is positioned relative to the image forming apparatus 1 by bringing an outer surface 71a of the first frame 71 located on the upstream side in the transport direction into contact with a seating surface 100a fixed to the housing 100 of the image forming apparatus 1 and provided perpendicularly to the transport direction.

In the example of FIG. 8A, the outer surface 71a of the first frame 71, which is normally formed by a flat surface along the pressurizing direction and the axial direction, is inclined with respect to the flat surface along the pressurizing direction and the axial direction.

In this case, as illustrated in FIG. 8A, when the fixing unit 60 is attached with the outer surface 71a being in contact with the seating surface 100a of the image forming apparatus 1, the rotation axis of the heating roller 61 is inclined with respect to the direction perpendicular to the transport direction, and this reduces the positioning accuracy of the heating roller 61.

In the example of FIG. 8B, the outer surface 71a of the first frame 71 is formed by a flat surface along the pressurizing direction and the axial direction, but the rotation axis of the heating roller 61 is inclined with respect to the outer surface 71a.

In this case, as illustrated in FIG. 8B, when the fixing unit 60 is attached with the outer surface 71a being in contact with the seating surface 100a of the housing 100, the rotation axis of the heating roller 61 is also inclined with respect to the direction perpendicular to the transport direction, and this reduces the positioning accuracy of the heating roller 61.

Even when there is no error in the outer shape of the unit frame 70 and the attachment position of the heating roller 61 in the unit frame 70, the positional accuracy of the heating roller 61 is sometimes deteriorated by, for example, thermal deformation of the unit frame 70 due to heat generation from the heating roller 61 or load deformation due to load generated between the first frame 71 and the second frame 72.

Such deformation of the unit frame 70 is apt to occur particularly when the unit frame 70 is formed of resin.

In contrast, in the first exemplary embodiment, the heating roller 61 is positioned in the image forming apparatus 1 by directly attaching the bearings 615 of the heating roller 61 to the bearing positioning portions 120 of the attachment member 110 fixed to the housing 100 of the image forming apparatus 1.

Next, the structure of the attachment member 110 and positioning of the fixing unit 60 in the image forming apparatus 1 according to the first exemplary embodiment will be described in detail with reference to FIGS. 5, 6, and so on described above.

The attachment member 110 of the first exemplary embodiment extends long in the axial direction as a whole. Also, the attachment member 110 is formed by a conductive member such as SUS.

In the attachment member 110, the guide portion 111 is formed by a wall surface extending in the axial direction and the pressurizing direction.

The bearing positioning portions 120 of the first exemplary embodiment are respectively provided at one end and the other end of the attachment member 110 in the axial direction.

Each bearing positioning portion 120 has a substantially angular-U shape to be open toward the upstream side in the pressurizing direction when viewed from the axial direction. Specifically, the bearing positioning portion 120 is formed by a sheet metal bent in a substantially angular-U shape. The bearing positioning portion 120 has two opposed surfaces 121 and 122 that are formed by flat surfaces parallel to the axial direction and the pressurizing direction and are opposed to each other with a gap therebetween in the transport direction. In the first exemplary embodiment, the gap between the opposed surface 121 and the opposed surface 122 of the bearing positioning portion 120 is substantially equal to the outer diameter of the insertion portion 615a of the corresponding bearing 615.

When the fixing unit 60 is attached to the attachment member 110 of the first exemplary embodiment, the unit frame 70 of the fixing unit 60 is first placed on the guide portion 111. Then, the fixing unit 60 is entirely moved in the pressurizing direction and inserted into the attachment member 110 in the state in which the unit frame 70 is placed on the guide portion 111.

Subsequently, the insertion portions 615a of the bearings 615 provided in the heating roller 61 of the fixing unit 60 are inserted in the pressurizing direction into the corresponding bearing positioning portions 120 of the attachment member 110. Specifically, as illustrated in FIG. 5, the insertion portions 615a of the bearings 615 are inserted in the pressurizing direction of the pressurizing module 62 into the openings of the bearing positioning portions 120. Thus, the opposed surfaces 121 and the opposed surfaces 122 of the bearing positioning portions 120 come into contact with the outer peripheral surfaces of the insertion portions 615a of the bearings 615 from the upstream side and the downstream side in the transport direction.

As described above, the bearing positioning portions 120 of the first exemplary embodiment are each formed by a sheet metal. For this reason, when the bearings 615 are inserted in the openings of the bearing positioning portions 120, the opposed surfaces 121 and the opposed surfaces 122 press the insertion portions 615a of the bearings 615 in the transport direction by elastic restoring force of the bearing positioning portions 120. Thus, the bearings 615 are fixed in the bearing positioning portions 120, and are positioned in the transport direction. As a result, the heating roller 61 is positioned in the transport direction via the bearings 615.

Further, as described above, in the fixing unit 60 of the first exemplary embodiment, the heating roller 61 is attached to the first frame 71 of the unit frame 70. In the unit frame 70, the first frame 71 to which the heating roller 61 is attached and the second frame 72 to which the pressurizing module 62 is attached are connected to each other.

Thus, the heating roller 61 is positioned relative to the bearing positioning portions 120, and the fixing unit 60 is entirely positioned in the transport direction in the apparatus body of the image forming apparatus 1 via the heating roller 61.

The bearing positioning portions 120 and the guide portion 111 of the attachment member 110 of the first exemplary embodiment are each formed by a conductive member, such as SUS, as described above. Thus, in the fixing unit 60 of the first exemplary embodiment, when the bearings 615 are inserted in the bearing positioning portions 120 and are brought into contact with the opposed surfaces 121 and 122 of the conductive bearing positioning portions 120, the heating roller 61 is grounded via the bearings 615.

In the first exemplary embodiment, since the heating roller 61 is grounded via the bearing positioning portions 120, for example, even when the unit frame 70 is formed of resin having no conductivity, it is unnecessary to provide other members to ground the heating roller 61.

### Second Exemplary Embodiment

Next, a second exemplary embodiment of the present invention will be described. While the bearing positioning portions 120 used in the above-described first exemplary embodiment have the opposed surfaces 121 and 122 and are substantially angular-U-shaped, the shape of the bearing positioning portions 120 is not limited as long as it allows the bearings 615 to be positioned in the transport direction.

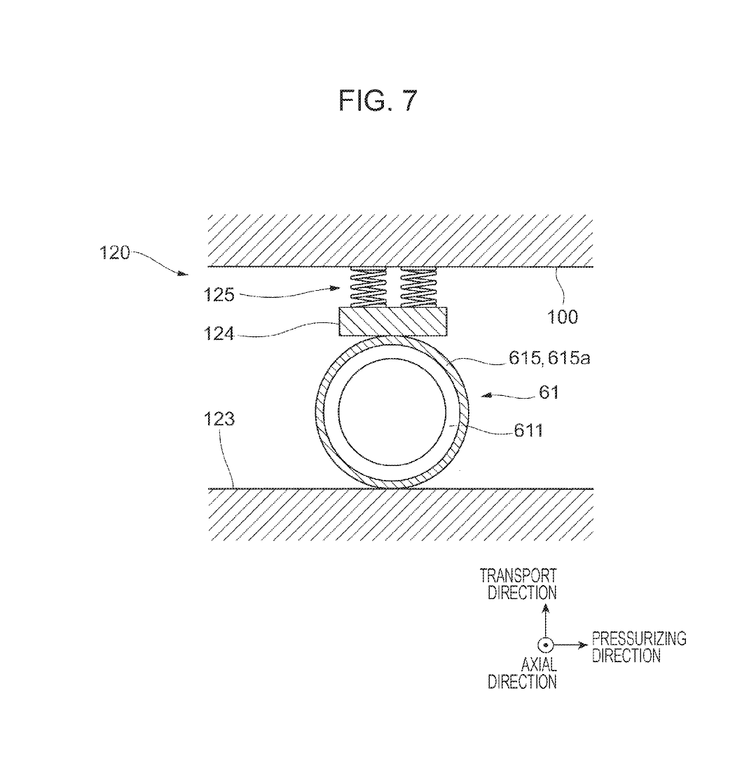

FIG. 7 illustrates the shape of a bearing positioning portion 120 and a state of a bearing 615 positioned by the bearing positioning portion 120 in the second exemplary embodiment. In the description of the second exemplary embodiment, structures similar to those adopted in the above-described first exemplary embodiment are denoted by similar reference numerals, and detailed descriptions thereof are skipped.

As illustrated in FIG. 7, each bearing positioning portion 120 of the second exemplary embodiment includes a bearing support surface 123 formed by a wall surface fixed to a housing 100 of an image forming apparatus 1 (see FIG. 1) and extending in the pressurizing direction and the axial direction, and an opposed member 124 serving as an example of a contact portion opposed to the bearing support surface 123 with a predetermined gap therebetween and fixed to the housing 100 with an elastic member 125 serving as an example of a pressing portion being disposed therebetween.

In the bearing positioning portion 120 of the second exemplary embodiment, the opposed member 124 is moved in the transport direction by expansion and contraction of the elastic member 125.

In the second exemplary embodiment, when a fixing unit 60 is attached to the image forming apparatus 1, each bearing 615 of a heating roller 61 is inserted between the bearing support surface 123 and the opposed member 124. Thus, the bearing support surface 123 and the opposed member 124 come into contact with an outer peripheral surface of an insertion portion 615a of the bearing 615 from the upstream side and the downstream side in the axial direction.

Further, the opposed member 124 presses the insertion portion 615a of the bearing 615 in the transport direction by elastic restoring force of the elastic member 125. Thus, the bearing 615 is fixed and positioned in the transport direction in the bearing positioning portion 120. As a result, the heating roller 61 is positioned in the transport direction via the bearing 615.

In the second exemplary embodiment, the heating roller 61 is grounded via the bearing 615 by forming the bearing support surface 123, or the opposed member 124 and the elastic member 125 by a conductive member.

In the first and second exemplary embodiments described above, the fixing unit 60 in which the heating roller 61 and the pressurizing module 62 are stored in the unit frame 70 is given as an example of an object to be positioned. However, the object to which the present invention is applied is not limited thereto. For example, the present invention is similarly applicable to a case in which a transfer unit including a transfer roller serving as a roll member stored in a frame or a developing unit including a developing roller serving as a roll member stored in a frame is attached to the apparatus body of the image forming apparatus 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an apparatus body including an image forming unit that is configured to form an image on a recording material; and
a fixing unit that is removably attached to the apparatus body and is configured to fix the image on the recording material on which the image is formed by the image forming unit,
wherein the fixing unit includes
a roll member having a cylindrical roll body and a bearing provided at each end of the roll body to support the roll body rotatably,
a pressurizing member provided in contact with the roll member to form, between the pressurizing member and the roll member, a fixing pressurizing portion through which the recording material passes, and
a storage member that is configured to store the roll member and the pressurizing member in a state in which the roll member and the pressurizing member are pressed with a predetermined pressure, and
wherein the apparatus body includes a positioning member that is in contact with the bearing of the roll member stored in the storage member to position the roll member in a transport direction of the recording material.

2. The image forming apparatus according to claim 1,
wherein the positioning member of the apparatus body is formed of a conductive material, and
wherein the roll member of the fixing unit is grounded by contact of the bearing with the positioning member.

3. The image forming apparatus according to claim 1, wherein the storage member of the fixing unit is formed of a resin material.

4. The image forming apparatus according to claim 2, wherein the storage member of the fixing unit is formed of a resin material.

5. The image forming apparatus according to claim 1, wherein the positioning member of the apparatus body includes a contact portion in contact with the bearing in the transport direction and a pressing portion that is configured to press the contact portion against the bearing in the transport direction.

6. The image forming apparatus according to claim 2, wherein the positioning member of the apparatus body includes a contact portion in contact with the bearing in the transport direction and a pressing portion that is configured to press the contact portion against the bearing in the transport direction.

7. The image forming apparatus according to claim 3, wherein the positioning member of the apparatus body includes a contact portion in contact with the bearing in the transport direction and a pressing portion that is configured to press the contact portion against the bearing in the transport direction.

8. The image forming apparatus according to claim 4, wherein the positioning member of the apparatus body includes a contact portion in contact with the bearing in the transport direction and a pressing portion that that is configured to press the contact portion against the bearing in the transport direction.

9. The image forming apparatus according to claim 1,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

10. The image forming apparatus according to claim 2,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

11. The image forming apparatus according to claim 3,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

12. The image forming apparatus according to claim 4,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

13. The image forming apparatus according to claim 5,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

14. The image forming apparatus according to claim 6,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

15. The image forming apparatus according to claim 7,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

16. The image forming apparatus according to claim 8,
wherein the storage member of the fixing unit has a pressed portion against which the bearing of the roll member is pressed in a pressurizing direction of the pressurizing member, and
wherein the roll member of the fixing unit is positioned in the storage member in the pressurizing direction with the bearing being pressed against the pressed portion.

17. An image forming apparatus comprising:
an apparatus body including an image forming unit that forms an image on a recording material; and
a unit part removably attached to the apparatus body,
wherein the unit part includes
a roll member having a cylindrical roll body and a bearing provided at each end of the roll body to support the roll body rotatably, and
a storage member that stores the roll member, and
wherein the apparatus body includes a positioning member that is in contact with the bearing of the roll member stored in the storage member to position the roll member in a direction intersecting an axial direction of the roll member.
